(19) United States
(12) Patent Application Publication
(10) Pub. No.: US 2009/0196563 A1
(43) Pub. Date: Aug. 6, 2009

(54) Multi-Fiber Optical Patch Cord Breakout Assembly

(76) Inventors: David M. Mullsteff, Glen Allen, VA (US); John P. Taylor, Richmond, VA (US); Mark A. Gervasoni, Midlothian, VA (US)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/361,239

(22) Filed: Jan. 28, 2009

Related U.S. Application Data
(60) Provisional application No. 61/025,468, filed on Feb. 1, 2008.

(51) Int. Cl. G02B 6/00

(52) U.S. Cl. 385/135

(57) ABSTRACT

A fiber cable adapter comprises adjacent rows of fibers, each beginning with a set of fibers comprising a fiber pair, which comprises a transmitting fiber adjacent a receiving fiber, and a spare fiber adjacent the fiber pair. The spare fiber immediately precedes the fiber pair in one of the rows and immediately proceeds the fiber pair in the other row. A fiber cable cassette comprises an adapter panel supporting the fiber cable adapter. An integrated fiber cable management system comprises a fitting having a body with a collet through which a cable passes. A lock nut is threaded on a first end of the body to hold the body in relation to a chassis. A sealing nut is threaded on a second end of the body to tighten the collet on the cable to hold the cable in place in relation to the chassis. A flexible protector extends from the sealing nut to control the bend of the cable between the chassis and a fiber cable cassette. The flexible protector restricts the bend of the cable and thus extends the life of the cable.

### CROSS-REFERENCE TO RELATED APPLICATIONS

This application claims the benefit of U.S. Provisional Application No. 61/025,468 filed Feb. 1, 2008, the disclosure of which is incorporated herein by reference.

### BACKGROUND OF THE INVENTION

The invention relates generally to optical communications and more particularly to fiber optic cables and connections used for connecting electronic equipment used in the transmission of digital and analog data.

In the field of data communications, fiber optic cables have surpassed electric cables because of their enormous bandwidth capabilities. As technology grows and more demands are being placed on data transfer, the need for higher bandwidth and more connections is growing. Additionally, while demand for more bandwidth and more connections grows, the cost for space allocated to data communications increases, creating a clash between adding more connections and cost.

Fiber optic cables used in data communications are terminated at each end with connectors that plug into various pieces of electrical equipment. These cables are usually not run continuously from one terminus to another, but connect to other cables through a chassis that house cassettes for mating with fiber optic cable connectors.

Fiber optic cables typically have either a loose construction or a ribbon construction. Fiber optic cables with loose construction contain separate fibers in bundles within a cable following a standard color pattern. In known solutions, fibers are terminated individually and mated to other similarly terminated fibers to complete the connection. Ribbon fiber optic cables are constructed of the same loose colorized fibers as round cables but are laid in a planar array following the same standard color pattern. They are then coated with a common layer and irradiated with a UV light source that cures them in that common layer.

Round or ribbon cable fibers are terminated either with a breakout that separates the fibers for individual conventional connectors, such as ST, SC, LC, and MU connectors, or with multi-fiber connectors, such as MPO (multi-fiber push on) connectors. One very successful MPO connector is a MTP® brand connector, which is a mechanical transfer pull off connector manufactured and sold by US CONEC LTD of Hickory, N.C.

In known fiber optic communication systems, a fiber optic cable is typically terminated in groups of 12 fibers or less to connectors of the same strand count. In multi-fiber connectors, there is a problem with light separation between fibers at high bit-rate transmission levels (e.g., beyond ten Gigabit per second (10 GB/S)). Lack of adequate light separation results in crosstalk, which reduces the efficiency and effectiveness of the fiber optic connection. Crosstalk causes, among other problems, bit error and data corruption. As a result, repeated signal transmission is required.

### SUMMARY OF THE INVENTION

The present invention relates to a fiber cable adapter comprising adjacent rows of fibers. Each row begins with a set of fibers comprising a fiber pair, which comprises a transmitting fiber adjacent a receiving fiber, and a spare fiber adjacent the fiber pair. The spare fiber immediately precedes the fiber pair in one of the rows and immediately proceeds the fiber pair in the other row. The invention also relates to a fiber cable cassette comprising an adapter panel supporting a fiber cable adapter according to the present invention.

The present invention further relates to a fiber optic communication system. The system comprises a chassis. A cassette is housed within the chassis. The cassette has a fiber cable adapter. A fiber cable comprises a fiber optic connector connected to the fiber cable adapter. An integrated fiber cable management system comprises a fitting having a body with a collet through which the cable passes. A lock nut is threaded on a first end of the body to hold the body in relation to the chassis. A sealing nut is threaded on a second end of the body to tighten the collet on the cable to hold the cable in place in relation to the chassis. A flexible protector extends from the sealing nut to control the bend of the cable between the chassis and the cassette. The flexible protector restricts the bend of the cable and thus extends the life of the cable.

Various advantages of this invention will become apparent to those skilled in the art from the following detailed description of the preferred embodiment, when read in light of the accompanying drawings.

### BRIEF DESCRIPTION OF THE DRAWINGS

The present invention will be appreciated more fully from the following detailed description, taken in conjunction with the drawings in which:

FIG. 1 is a top plan view of an exemplary high-density fiber optic communication system.

FIG. 2 is a partially exploded front perspective view of an exemplary chassis of the high-density fiber optic communication system shown in FIG. 1.

FIG. 3 is a front perspective view of an exemplary cassette of the high-density fiber optic communication system shown in FIG. 1.

FIG. 4 is a diagrammatical view of an exemplary fiber optic cable showing elements that allow a high-density connection.

FIG. 5 is a diagrammatical view of another exemplary fiber optic cable showing elements that allow a high-density connection.

FIG. 6 is a cross-section of two fiber optic cable legs jacketed together to produce a shotgun style construction fiber optic cable, wherein each leg includes 72 fibers.

FIG. 7 is a cross-section of a fiber optic cable leg that includes 48 fibers.

FIG. 8 is a schematic view of a high-density fiber optic cable showing multi-fiber connectors.

FIG. 9 is a diagrammatical view of a 24-fiber connector pattern.

FIG. 10 is a diagrammatical view of a 48-fiber connector pattern.

FIG. 11 is a diagrammatical view of a 72-fiber connector pattern.

FIG. 12 is an exploded, side elevational view of an exemplary integrated cable management system including a fitting integral with a cable, wherein the fitting include a flexible protector that controls the bend of the cable.

FIG. 13 is an end view of the fitting shown in FIG. 12 cooperating with a portion of the chassis shown in FIG. 1.

FIG. 14 is a top plan view of the fitting holding a fiber optic cable in position in relation to the chassis and a cassette, wherein the chassis has a panel removed.

### DETAILED DESCRIPTION OF THE PREFERRED EMBODIMENT

Detailed reference will now be made to the drawings in which examples embodying the present invention are shown. The detailed description uses words and phrases as identifiers on the drawings. Like or similar designations in the drawings and description have been used to refer to like or similar parts of the invention. The following description is merely exemplary in nature and is not intended to limit the present invention, or its application or uses. It should be understood that throughout the drawings, corresponding reference numerals indicate like or corresponding parts and features.

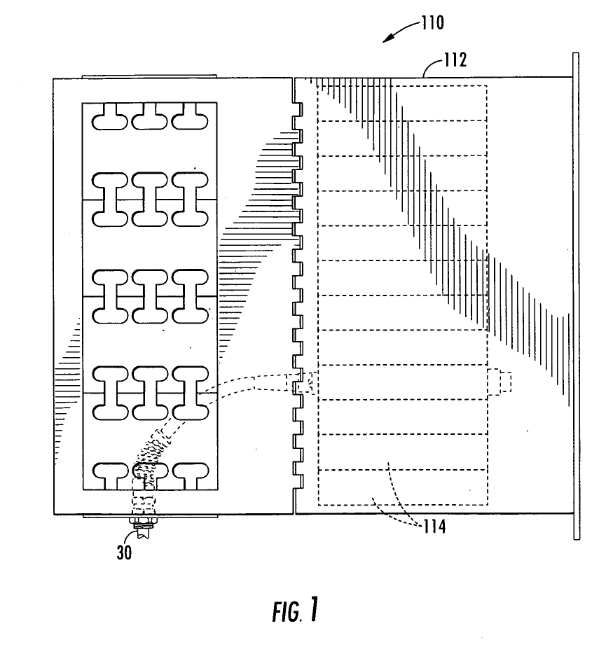

As shown generally in FIG. 1, a high-density fiber optic communication system 110 generally comprising a fiber chassis 112, cassettes 114 housed within the chassis 112, and a high-density fiber optic cable 30 connected to the cassette 114 via connectors, all of which will be described in further detail in the description that follows.

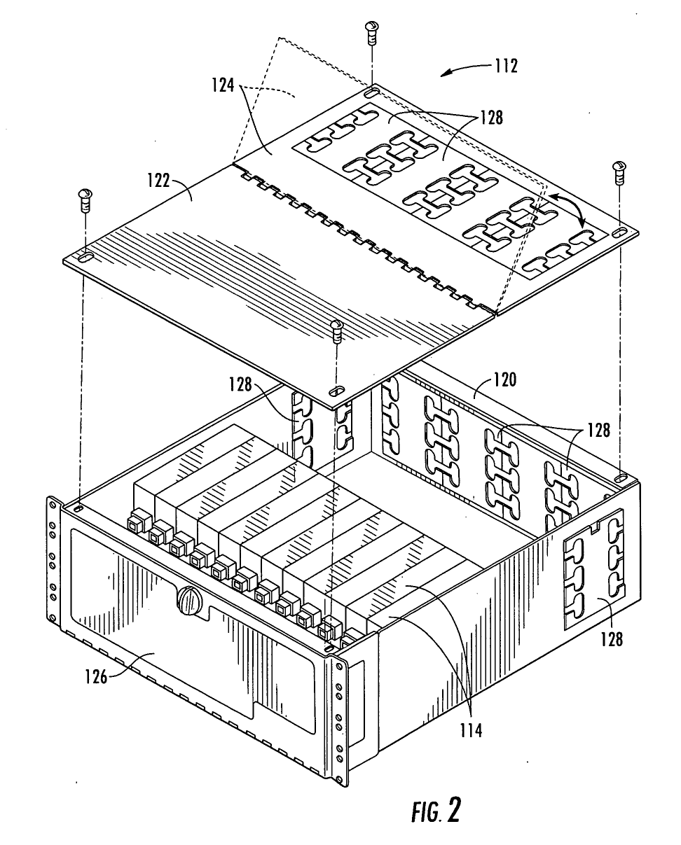

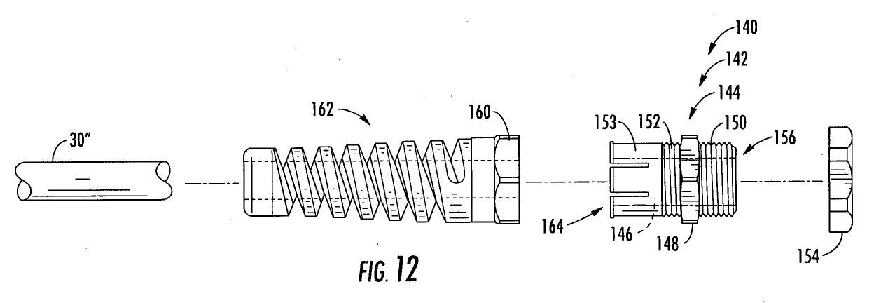

An exemplary chassis 112 is shown in FIG. 2. The chassis 112 may take on any suitable form, including, for example, a 4U rack mount chassis. The chassis 112 may comprise a housing 120, which may be metal or some other suitable construction. The housing 120 may have a removable panel 122 to permit ease of access within the housing 120. The removable panel 122 may have a hinged portion 124 that provides limited access within the housing 120. The housing 120 may further have a locking front 126, as show in the drawings, to permit access to cassettes 114 therein. The housing 120 may be provided with brackets 128, or other suitable structure, removable or non-removable, for the passage and, if desired, support of the high-density fiber optical cables 30. The brackets 128 may be located along the sides, back and top of the housing 120, or located in a suitable location. The brackets 128 may be configured to support an integrated cable management system 140, which will be described in further detail with reference to FIGS. 12-14 in the description that follows. The housing 120 may house a plurality of slots, or other structure, sufficient for receiving cassettes 114. In the illustrated embodiment, 12 slots are provided, each for receiving a cassette, although fewer or more slots may be provided. The chassis 112 is structured and dimensioned to be supported by a rack (not shown), which is structured and dimensioned to support a plurality of chassis, such as in a vertically stackable manner. In addition to housing high-density fiber optic cassettes 114, the chassis 112 may house adapter panels, CAT5E cassettes, media converters, as well as other data communication components.

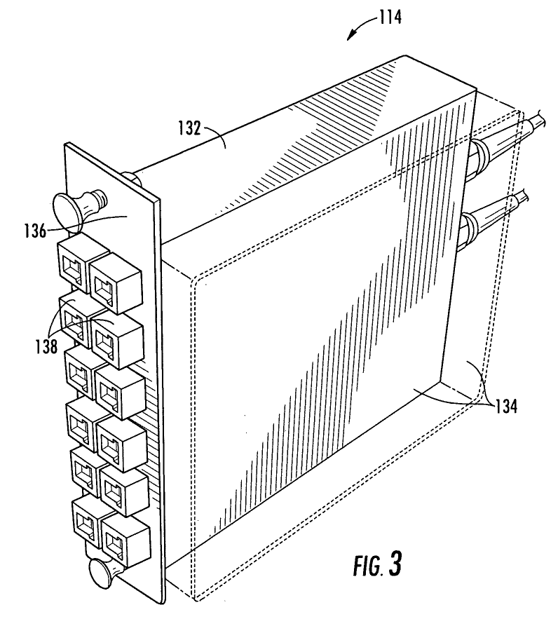

The high-density fiber optic cassettes 114 housed within the chassis 112 may take on any suitable form. As shown in FIG. 3, the high-density fiber optic cassettes 114 may be comprised of a housing 132, which may be metal or some other suitable construction. The housing 132 may have a removable panel 134 to permit ease of access within the housing 132. The housing 132 may be provided with fiber adaptor panels 136, or other suitable structure, removable or non-removable, which support adapters 138, which may be connected to the high-density fiber optical cables 30. Each brand high-density fiber optic cassette may support 24 or more fibers. The number of fibers supported depends on the fiber adaptor panel 136 employed, as will become apparent in the description that follows. The cassettes 114 may be supported in the chassis 112 in any suitable manner, including, for example, with push grommets supported in relation to adaptor panel portions extending from the sides of the cassettes 114, wherein the push grommets may be pushed through holes (not shown) associated with respective slots and an insert may be pushed through the grommet.

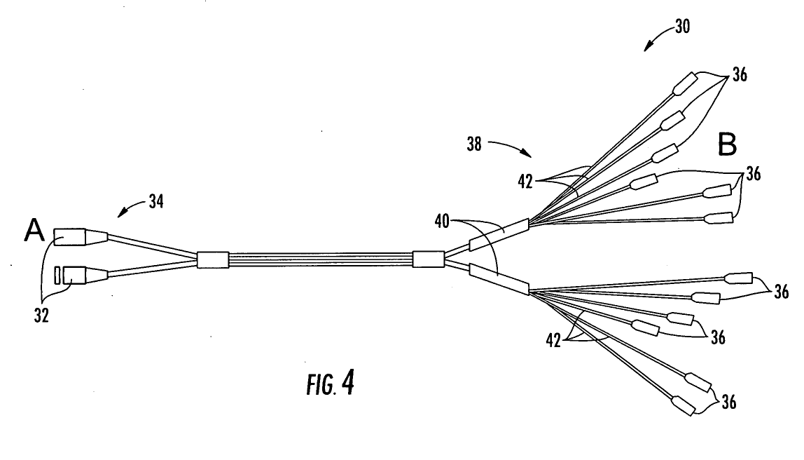

The high-density fiber optical cables 30 may include 24 fibers or more. As shown in FIG. 4, the cables 30 may terminate at a first pair of high-density fiber optic connectors 32 at a first end 34 and a series of subunit connectors 36 at a second end 38. This first pair of high-capacity connectors 32 may include 24 to 72 fibers. The subunits may be terminated to 12-fiber connectors that follow a color code as set out in TIA/EIA 598 “Optical Fiber Color Coding.” The connectors may then be polished by commonly used craft equipment.

As further shown in FIG. 4, a pair of break-out housings 40 may be located near the second end 38 and may be adapted to split a single high-density fiber optic cable 30 into individual fibers 42, which may terminate in the series of subunit connectors 36. It should be understood by those skilled in the art that the individual fibers 42 may be combined together and terminated together as necessary for certain applications, for example, when two individual fiber optic cables 42 that operate as a transmitting and receiving link to a piece of electronic equipment are housed in a common sleeve and terminated to a common subunit connector 36.

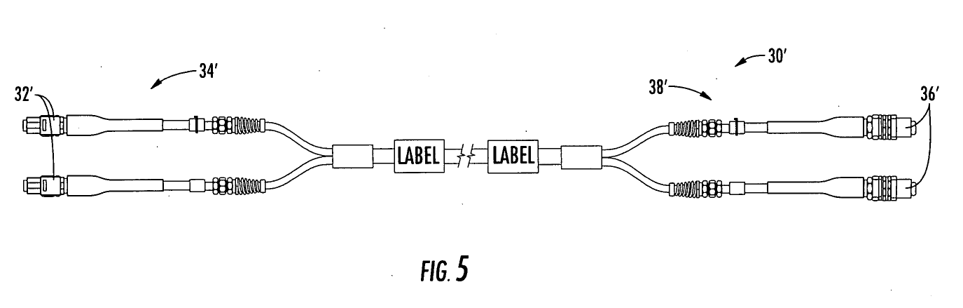

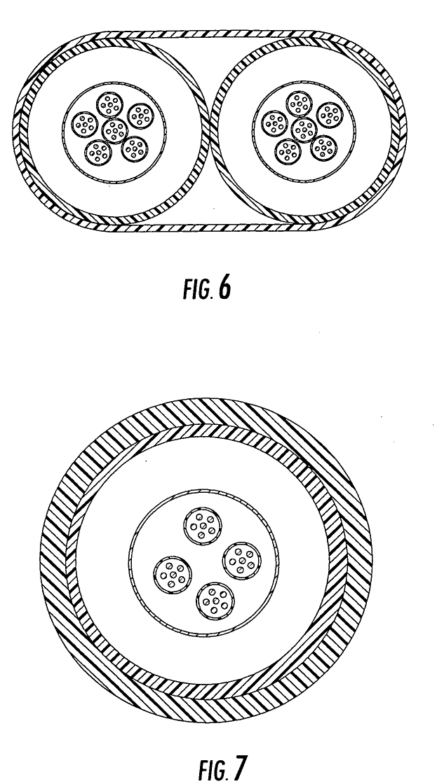

An example of another cable 30′ may include a 144-fiber brand backbone harness. The 144-fiber brand backbone harness is shown in FIG. 5. The backbone harness may include two fiber legs jacketed together to produce a shotgun style construction, as shown in FIG. 6. Each leg may include 72 fibers. Alternatively, each a fiber leg may include 48 fibers, like the fiber leg show in FIG. 7, to form a 96-fiber brand backbone harness. The backbone harness may terminate at a first pair of high-density fiber optic connectors 32′ at a first end 34′ and a second pair of connectors 36′ at a second end 38′.

It should be understood that, depending on the cable and connectors employed, the cassettes 114 may support, for example, 24, 48, 72, 96 and 144 fibers, or in the case of a feed through cassette, up to 864 fibers. Two 12 fiber-legs can form a 24-fiber cable. Two 24 fiber-legs can form a 48-fiber cable. Two 48 fiber-legs can form a 96-fiber cable. Two 72 fiber-legs can form a 144-fiber cable. It should further be understood that various combinations of cables can be used with various combinations of connectors, for example, 12 72-fiber connectors on both the front and back of the cassette 114 can be used to feed through 864 fibers (12 72-fiber cables).

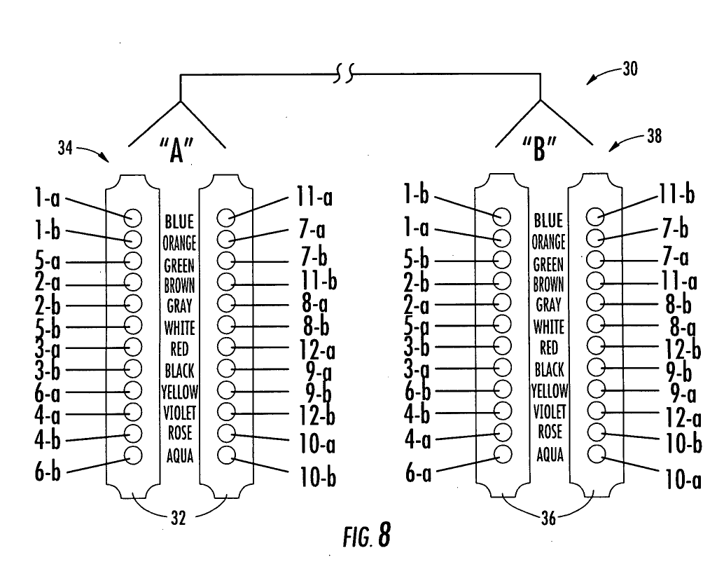

In FIG. 8, there is illustrated a high-density fiber optic cable 30 with multi-fiber connectors. The fiber optic cable 30 may have high-density fiber optic connectors 32, 36 at the first and second ends 34, 38 in a ribbon construction and the industry standard TIA/EIA 598 color coding mentioned above. It should be understood by those skilled in the art that this invention may be applicable for use with layouts of fiber optic cables and other styles of fiber optic connectors.

It should be understood by those skilled in the art that multi-fiber optical cables may comprise pairs of fibers. Each pair may be generally designated by a mutual number and a distinct letter (1-a, 1-b, 2-a, 2-b, etc.). Pairs are often used because most electronic equipment that accepts fiber optic cable operates in a full-duplex mode that requires distinct transmitting and receiving fibers. Therefore, the pairing of fibers keeps the ends matched up with their respective transmitting and receiving channels.

Continuing with reference to FIG. 8, an exemplary termination numbering scheme is shown for each end of the fiber optic cable 30 shown in FIG. 4. At the first end 34 (designated the “A” side), the termination scheme is “1-a, 1-b, 5-a, 2-a, 2-b, 5-b, 3-a, 3-b, -6-a, 4-a, 4-b, 6-b” on one of the first pair of high-density fiber optic connectors 32 and is “11-a, 7-a, 7-b, 11-b, 8-a, 8-b, 12-a, 9-a, 9-b, 12-b, 10-a, 10-b” on the other connector 32. At the second end 38 (designated the “B” side), the termination schemes that match the color codes of the first end 34 are shown as “1-b, 1-a, 5-b, 2-b, 2-a, 5-a, 3-b, 3-a, 6-b, 4-b, 4-a, 6-a” and “11-b, 7-b, 7-a, 11-a, 8-b, 8-a, 23-b, 9-b, 9-a, 12-a, 10-b, 10-a.”

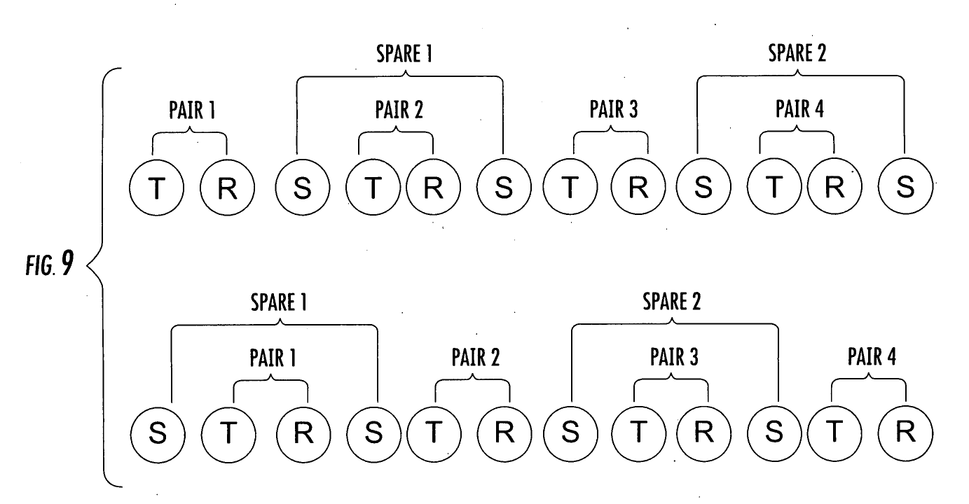

A pattern of interspersing individual fibers between fiber pairs separates light paths between fibers in order to provide better optical performance with reduced crosstalk. In FIG. 9, an example of a 24-fiber optic cable with such a pattern is illustrated. In the example, transmitting fibers T and receiving fibers R are paired to form the transmitting and receiving fiber pairs that are separated by spare fibers S. A first 12 fibers thus has four transmitting and receiving fiber pairs and two spare fiber pairs, four spare fibers S in all, arranged so as to separate the four transmitting and receiving fiber pairs, as shown in the drawing. An adjacent second 12 fibers similarly have four transmitting and receiving fiber pairs but the transmitting and receiving fiber pairs are shifted by a spare fiber S in relation to the first 12 fibers so as to separate the transmitting fibers T of the first 12 fibers from adjacent transmitting fibers T of the second 12 fibers, and separate the receiving fibers R of the first 12 fibers from adjacent receiving fibers R of the second 12 fibers. This results in a diagonal separation between transmitting fibers T and a diagonal separation between receiving fibers R that is sufficient to reduce crosstalk caused by light transmitted between like fibers.

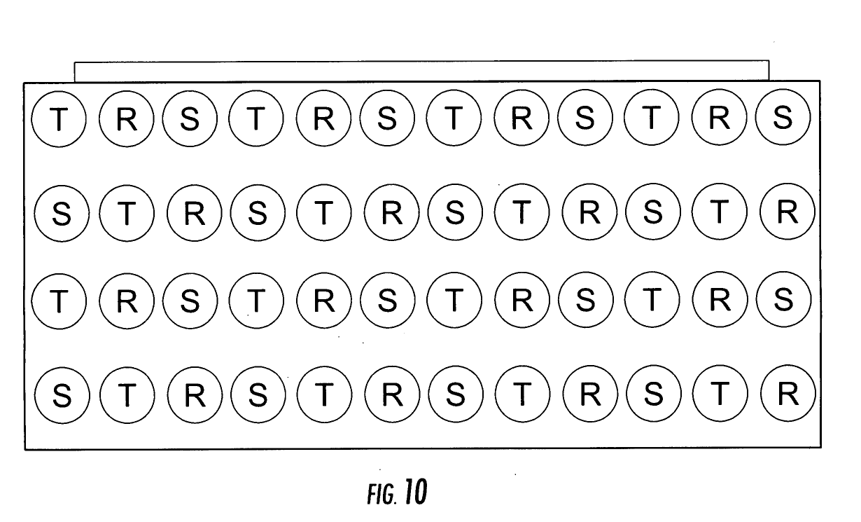

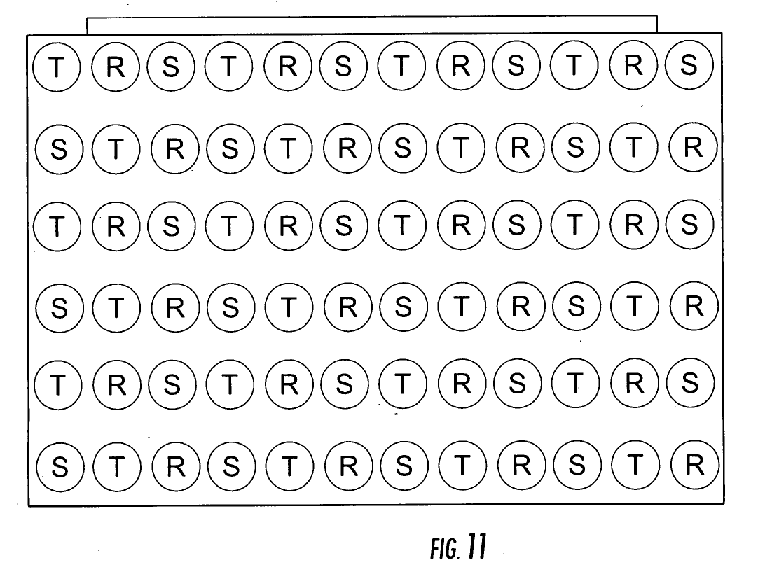

The above described a pattern may be repeated. For example, a 48-fiber cable may have a pattern that is repeated, as illustrated in FIG. 10. A 72-fiber cable may similarly have a pattern that is repeated, as illustrated in FIG. 11. It should be understood that two 72-fiber optical cables, within a single trunk cable, having a 72-fiber connector may be optically connected to a cassette 114, wherein 144 fibers may be distributed into six different 24-fiber cables, each terminating in a 24-fiber connector, such as the 24-fiber connector. A first end of a fiber optic cable may be optically connected to each of the 24-fiber connectors. A second end of the fiber optic cable may be terminated in each of the subunit connectors. Using the termination scheme, as described above, crosstalk problems traditionally associated with such high-density fiber optic cables can be avoided. As a result, 144 separate fiber connections can be established between two locations using only a single trunk cable with a cross section of only about 12 square centimeters. Additionally, 12 cassettes 114 can be arranged within a single chassis 112, such as a 4U rack mount chassis, thus allowing 1728 individual fiber connections to be established while only occupying four units of rack mount space.

In FIG. 12, there is illustrated an integrated cable management system, as mention above. The system, which is generally indicated at 140, may comprise, among other features, a fitting 142 integral with a cable, such as the cable 30″ shown in FIG. 5. The fitting 142 may comprise a body 144 having a clearance hole 146 passing therethrough. An integral nut 148 may be located proximate the axial center of the body 144. Threads 150, 152 (e.g., Acme or other suitable threads) may be provided on opposing sides to the integral nut 148. A collet 153 may be provided to accommodate various size cables. A lock nut 154 may be threaded on the threads 150 at a first end 156 of the body 144 to hold the body 144 in fixed relation to the chassis 112, as will become apparent in the description that follows. Acme threads may prevent skipping and speed up installation. A sealing nut 160, with an integral flexible protector 162 extending therefrom, may be threaded on the threads 152 at a second end 164 of the body 144. The flexible protector 162 may provide lazy bend protection for the cable 30″ to prevent sharp bends and extend the cable life.

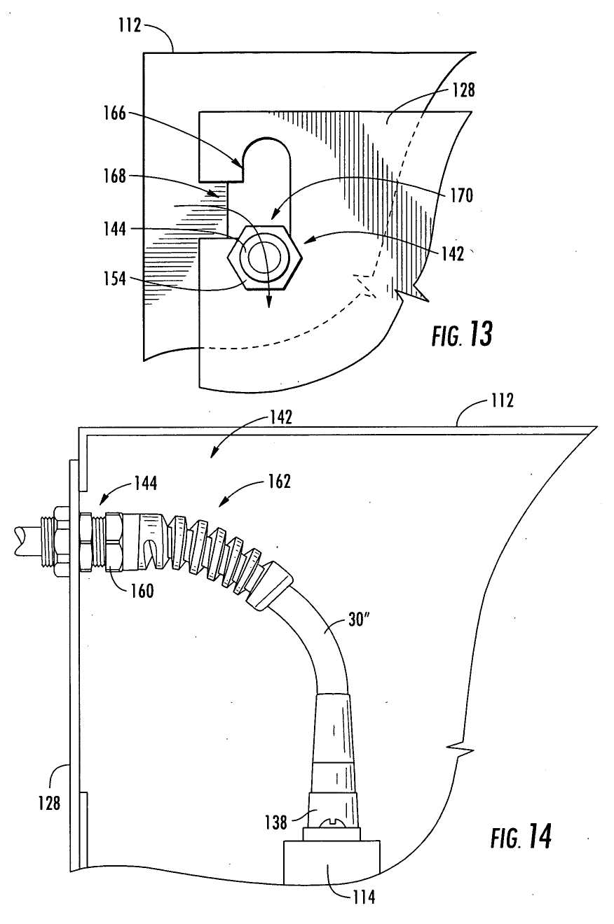

The fitting 142 may be fixed in relation to the chassis 112 via the brackets 128. This may be done with any suitable structure. For example, as shown in FIG. 13, the brackets 128 may comprise one or more substantially T-shaped openings 166. The opening 166 may extend to the edge of the bracket 128. With the bracket 128 removed, the first end 156 of the body 144 may pass through a first leg 168 of the opening 166 and be guided in a second leg 170. The second leg 170 may be perpendicular, transverse, or otherwise oriented in relation to the first leg 168. The locking nut 154 may be tightened onto the first end 156 of the body 144 and against the bracket 128 so as to hold the body 144 in fixed relation to the bracket 128. It should be noted that the first end 156 of the body 144 may face outwardly in relation to the bracket 128, or in relation to the chassis 112, when the bracket 128 is secured back in relation to the chassis 112.

With bracket 128 secured back in relation to the chassis 112, the cable 30″ may be adjusted in relation to the body 144, and the flexible protector 162, by axially displacing the cable 30″ through the clearance hole 146. The adjustment of the cable 30″ may include positioning the cable 30″ as desired, with a desired bend between the bracket 128 and the cassette 114. Once in a desired position, the sealing nut 160 may be tightened against the collet 153. In turn, the collet 153 tightens against the cable 30″ to hold the cable 30″ in the desired position, as shown, for example, in FIG. 14. The flexible protector 162 may prevent the cable 30″ from making a sharp bend. Although the flexible protector 162 is shown to have a helical construction, other constructions may be suitable.

The advantages of the above described embodiments and improvements are readily apparent to one skilled in the art as enabling the efficient and effective transmission of data. Additional design considerations may be incorporated without departing from the spirit and scope of the invention. Accordingly, it is not intended that the invention be limited by the particular embodiments or forms described above, but by the appended claims.

We claim:

1. A fiber cable adapter comprising:
a first row of fibers beginning with a first set of fibers comprising a pair of fibers, which comprises a transmitting fiber adjacent a receiving fiber, and a spare fiber adjacent the first set pair, and
a second row of fibers adjacent the first row, the second row beginning with a second set of fibers comprising a pair of fibers, which comprises a transmitting fiber adjacent a receiving fiber, and a spare fiber adjacent the second set pair, wherein one of the spare fiber immediately precedes the pair of fibers in one of the fiber sets and the spare fiber immediately proceeds the pair of fibers in the other one of the fiber sets.

2. The fiber cable adapter of claim 1, wherein the first set of fibers is one of three first sets of fibers repeating in the first row and the second set of fibers is one of three second sets of fibers repeating in the second row.

3. The fiber cable adapter of claim 1, wherein the first set is one of three first sets in the first row and the second set is one of three second sets in the second row arranged so that the first row spares separate the first pairs from one another and the second row spares separate the second pairs from one another so that each of the rows comprises 12 fibers and the two rows collectively comprise 24 fibers.

4. The fiber cable adapter of claim 3, wherein the first row is repeated in a third row and the second row is repeated in a fourth row, wherein the third row is adjacent the second row and the fourth row is adjacent the third row so that the four rows collectively comprise 48 fibers.

5. The fiber cable adapter of claim 4, wherein the first row is repeated in a fifth row and the second row is repeated in a sixth row, wherein the fifth row is adjacent the fourth row and the sixth row is adjacent the fifth row so that the six rows collectively comprise 72 fibers.

6. The fiber cable adapter of claim 5, wherein the first row is repeated in a seventh row and the second row is repeated in a eighth row, wherein the seventh row is adjacent the sixth row and the eighth row is adjacent the seventh row so that the eight rows collectively comprise 96 fibers.

7. The fiber cable cassette comprising:
at least one adapter panel supporting at least one fiber cable adapter, the fiber cable adapter comprising:
a first row of fibers beginning with a first set of fibers comprising a pair of fibers, which comprises a transmitting fiber adjacent a receiving fiber, and a spare fiber adjacent the first set pair, and
a second row of fibers adjacent the first row, the second row beginning with a second set of fibers comprising a pair of fibers, which comprises a transmitting fiber adjacent a receiving fiber, and a spare fiber adjacent the second set pair, wherein one of the spare fiber immediately precedes the pair of fibers in one of the fiber sets and the spare fiber immediately proceeds the pair of fibers in the other one of the fiber sets.

8. The fiber cable cassette of claim 7, wherein the fiber cable adapter is one of a plurality of the fiber cable adapters supported by the at least one adapter panel.

9. The fiber cable cassette of claim 7, wherein the at least one adapter panel is one of two of the adapter panels and the fiber cable adapter is one of a plurality of the fiber cable adapters supported by the two adapter panels.

10. The fiber cable cassette of claim 7, wherein the first set of fibers is one of at least three of the first sets of fibers repeating in the first row and the second set of fibers is one of at least three of the second sets of fibers repeating in the second row so that each of the rows comprises 12 fibers and the two rows collectively comprise 24 fibers.

11. The fiber cable cassette of claim 10, wherein the first row is one of a plurality of the first rows and the second row is one of a plurality of the second rows arranged in an alternating arrangement with the three first rows, the six rows collective comprising up to 96 fibers.

12. The fiber cable cassette of claim 11, wherein the at least one fiber cable adapter is one of a plurality of the fiber cable adapters.

13. The fiber cable cassette of claim 12, wherein the at least one adapter panel is one of two of the adapter panels.

14. The fiber cable cassette of claim 13, wherein each one of the adapter panels supports twelve of the adapters, the twelve adapters collectively comprising 1152 fibers.

15. A fiber optic communication system comprising:
a chassis,
a cassette housed within the chassis, the cassette having a fiber cable adapter,
a fiber cable comprising a fiber optic connector connected to the fiber cable adapter, and
an integrated fiber cable management system comprising:
a fitting comprising:
a body having a collet through which the cable passes,
a lock nut threaded on a first end of the body to hold the body in relation to the chassis,
a sealing nut threaded on a second end of the body to tighten the collet on the cable to hold the cable in place in relation to the chassis, and
a flexible protector extending from the sealing nut to control the bend of the cable between the chassis and the cassette, the flexible protector restricting the bend of the cable and thus extending the life of the cable.

16. The system of claim 15, wherein the chassis comprises a bracket having an opening through which the fitting passes with the cable passing therethrough, the locking nut being tightened onto the first end of the body and against the bracket so as to hold the body in relation to the bracket.

17. The system of claim 16, wherein the bracket is a removable bracket having an edge and the opening is a, substantially T-shaped opening that extends to the edge of the bracket, wherein with the bracket removed, the first end of the body may pass through a first leg of the opening and be guided in a second leg of the opening, which is transverse to the first leg.

18. The system of claim 15, wherein the cable is adjustable in relation to the body and the flexible protector by loosening the sealing nut and axially displacing the cable through the hole, the adjustment of the cable including positioning the cable to achieve the bend between the bracket and the cassette.

19. The system of claim 15, wherein the flexible protector is a helical construction.
